(19) United States
(12) Patent Application Publication
(10) Pub. No.: US 2026/0099419 A1
(43) Pub. Date: Apr. 9, 2026

(54) System for Autonomous Refinement and Optimization of Multi-AI Agents

(71) Applicant: Aixplain, Inc., San Jose, CA (US)

(72) Inventors: Kamer Ali YUKSEL, Munchen (DE); Hassan SAWAF, San Jose, CA (US)

(73) Assignee: Aixplain, Inc., San Jose, CA (US)

(21) Appl. No.: 19/354,767

(22) Filed: Oct. 9, 2025

Related U.S. Application Data
(60) Provisional application No. 63/705,283, filed on Oct. 9, 2024.

(51) Int. Cl. G06F 11/34

(52) U.S. Cl. CPC G06F 11/3414

(57) ABSTRACT

An autonomous multi-agent refinement system is disclosed. A refinement controller comprising a large language model (LLM) receives configuration data defining a plurality of artificial intelligence (AI) agents with predefined roles, goals, and workflows, executes the agents to generate an output, and evaluates the output against LLM-generated qualitative and quantitative evaluation criteria. Based on the evaluation, the refinement controller generates a hypothesis to modify at least one of the roles, workflows, or inter-agent dependencies and implements a modified configuration to produce a modified output. In embodiments, the controller initializes agents from an idea description, synthesizes multiple hypotheses, executes corresponding configuration variants in parallel, and employs a comparison agent to compare outputs against a best-known output. A memory module stores and retrieves configurations and outputs to support iterative selection and reuse, while a documentation module records decisions and rationales.

This document is a United States Non-provisional utility patent application under statute 35 U.S.C. 111(A). This document claims priority and benefit to a U.S. Provisional utility patent application that is identified by a Serial No: 63/705,283 and that is titled “System for Autonomous Refinement and Optimization of Multi-AI Agents”, and that was filed with the U.S. Patent and Trademark Office (USPTO) on Oct. 9, 2024. The above-referenced document is herein incorporated by reference in its entirety.

### STATEMENT REGARDING PRIOR DISCLOSURE BY THE INVENTORS

Aspects of this technology are described in an article Ahmet Gunduz, Yunsu Kim, Kamer Ali Yuksel, Mohamed Al-Badrashiny, Thiago Castro Ferreira, Hassan Sawaf, “AutoMode-ASR: Learning to Select ASR Systems for Better Quality and Cost”, doi: doi.org/10.48550/arXiv.2409.1247, accepted for publication in SPECOM 2024 Conference, November 2024 and U.S. application Ser. No. 17/976,704, entitled “System and method for facilitating performing of tasks optimally using software applications”, filed on Oct. 28, 2022, which is incorporated herein by reference in its entirety.

### BACKGROUND

The Agent-based AI systems are widely employed in enterprise and technical settings to coordinate multiple specialized software agents that each perform portions of a larger workflow. Examples include, without limitation, market research pipelines in which data-gathering, synthesis, and reporting agents cooperate to deliver analysis; business process automation in which routing, compliance, and summarization agents interact with databases and application programming interfaces (APIs); and recommendation or content production workflows that combine retrieval, reasoning, critique, and formatting agents to generate domain-specific outputs. In standard multi-agent configurations, agents communicate over networks and invoke external tools or data sources to accomplish sub-tasks. Stability and quality of overall outcomes depend on appropriate definition of agent roles, task boundaries, dependencies, and ordering. As objectives, datasets, and operating conditions evolve, these configurations often require ongoing refinement to maintain accuracy, timeliness, and relevance.

Conventional approaches to improving multi-agent workflows rely heavily on manual inspection and ad-hoc tuning. Engineers typically review outputs, adjust prompts or code for individual agents, change task allocations or dependency graphs, and re-execute the pipeline. This approach is time-consuming, error-prone, and difficult to scale across varying domains. Known orchestration frameworks assist with composing agents and tools, but primarily emphasize task routing and execution order rather than structured refinement of the multi-agent configuration itself. Techniques in which large language models (LLMs) are used to judge or score generated content provide useful assessment signals, yet are generally applied to outputs of a given run and do not prescribe how scores should drive systematic changes to agent roles, workflows, or inter-agent dependencies. Self-critique or reflection methods enable an individual model to revise its own response across attempts, but these techniques do not address comparative selection among alternative system-level configurations of multiple agents nor persistent management of top-performing variants for reuse.

Representative prior efforts illustrate these limitations. Multi-agent orchestration toolkits describe controller-based composition of agents and tools to complete tasks, yet they focus on coordination mechanics and lack mechanisms for generating structural change proposals for the underlying agent graph or for ranking competing system variants against a maintained baseline. Work on “LLM-as-a-judge” demonstrates automated qualitative assessment and pairwise comparison of generated texts; however, such evaluators are not coupled to procedures for translating evaluations into concrete revisions of agent roles, workflows, or dependencies across iterations. Research on self-refinement for a single agent shows iterative improvement of a lone model's output using textual feedback, but does not contemplate storing and retrieving best-performing multi-agent configurations, nor comparing new configurations against a best-known configuration in order to control adoption of changes within a broader workflow.

Due to the absence of sufficiently adaptive, reproducible, and scalable refinement strategies in the foregoing approaches, multi-agent AI deployments remain vulnerable to performance drift as objectives and data distributions change. Manual tuning does not provide a consistent mechanism to: (a) derive qualitative and quantitative evaluation criteria appropriate to evolving tasks; (b) propose concrete hypotheses for changing agent roles, tasks, workflows, or dependencies; (c) implement and execute multiple modified configurations in a controlled manner; (d) compare outputs against a best-known configuration and determine a top-performing variant using transparent ranking; and (e) persist, retrieve, and reference prior configurations and outputs to support traceability and subsequent comparisons, all while integrating with external tools and enterprise data sources.

Accordingly, there exists a need for a framework in the art that systematically manages evaluation criteria, proposes and applies structural modifications to multi-agent configurations, executes alternative variants, and performs transparent comparisons against a maintained baseline with persistent storage and retrieval, thereby supporting scalable, repeatable improvement of agent-based AI workflows without reliance on ad-hoc manual intervention.

### SUMMARY OF THE INVENTION

In one exemplary embodiment, a computer-implemented method is described. The method comprises: receiving, using a refinement controller comprising a large language model (LLM), configuration data defining a plurality of artificial intelligence (AI) agents having predefined roles, goals, and workflows; executing, by the refinement controller, the plurality of AI agents to perform tasks based on the configuration data to generate an output; evaluating, by the refinement controller using the LLM, the output against evaluation criteria; generating, by the refinement controller, a hypothesis for modifying at least one of the roles, workflows, or inter-agent dependencies based on the evaluation; and implementing, by the refinement controller, a modified configuration of the plurality of AI agents according to the hypothesis to produce a modified output.

In another exemplary embodiment, a system is described. The system comprises: at least one processor; and a memory storing computer-executable instructions that, when executed by the at least one processor, cause the system to: receive, using a refinement controller comprising a large language model (LLM), configuration data defining a plurality of artificial intelligence (AI) agents having predefined roles, goals, and workflows; execute, by the refinement controller, the plurality of AI agents to perform tasks based on the configuration data to generate an output; evaluate, by the refinement controller using the LLM, the output against evaluation criteria; generate, by the refinement controller, a hypothesis for modifying at least one of the roles, workflows, or inter-agent dependencies based on the evaluation; and implement, by the refinement controller, a modified configuration of the plurality of AI agents according to the hypothesis to produce a modified output.

In yet another exemplary embodiment, a non-transitory computer-readable storage medium is described. The storage medium stores instructions which, when executed by at least one processor, cause the at least one processor to perform operations comprising: receiving, using a refinement controller comprising a large language model (LLM), configuration data defining a plurality of artificial intelligence (AI) agents having predefined roles, goals, and workflows; executing, by the refinement controller, the plurality of AI agents to perform tasks based on the configuration data to generate an output; evaluating, by the refinement controller using the LLM, the output against evaluation criteria; generating, by the refinement controller, a hypothesis for modifying at least one of the roles, workflows, or inter-agent dependencies based on the evaluation; and implementing, by the refinement controller, a modified configuration of the plurality of AI agents according to the hypothesis to produce a modified output.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a diagram showing an exemplary network system, according to certain embodiments.

FIG. 1B shows an exemplary architecture of an AI agent system implemented in a network environment, according to certain embodiments.

FIG. 1C is a block diagram that illustrates a first example of the AI agent system, according to certain embodiments.

FIG. 1D is a block diagram that illustrates a second example of the AI agent system, according to certain embodiments.

FIG. 2 illustrates an exemplary high-level architecture of a multi-agent refinement system and its networked operating context, according to certain embodiments.

FIG. 3 illustrates an exemplary initialization flow that converts an idea description into an executable multi-agent configuration of roles, workflows, and dependencies, according to certain embodiments.

FIG. 4 illustrates an exemplary variant synthesis and parallel execution process in which multiple hypotheses yield multiple modified configurations and corresponding outputs, according to certain embodiments.

FIG. 5 illustrates an exemplary arrangement in which LLM-generated evaluation criteria are applied to score outputs and are revised across iterations, according to certain embodiments.

FIG. 6 illustrates an exemplary comparison against a best-known configuration with a separate update action within a closed refinement loop, according to certain embodiments.

FIG. 7 illustrates an exemplary flow chart depicting initialization and baseline refinement, in accordance with an embodiment of the present disclosure.

FIG. 8 illustrates an exemplary flow chart depicting an iterative refinement loop with explicit comparison and update actions, in accordance with an embodiment of the present disclosure.

FIG. 9 illustrates an exemplary computer system suitable for implementing the multi-agent refinement technology, according to certain embodiments.

FIG. 10 is a schematic representation of an encoder-decoder architecture, in accordance with an embodiment of the present disclosure.

FIG. 11 shows an overview of an attention mechanism added onto an RNN encoder-decoder architecture, in accordance with an embodiment of the present disclosure.

FIG. 12 is a schematic representation of the calculation of self-attention showing one attention head, in accordance with an embodiment of the present disclosure.

FIG. 13 is a depiction of several attention heads in a Transformer block, in accordance with an embodiment of the present disclosure.

FIG. 14 is an illustration that shows how one can use multiple workers to compute the multi-head attention in parallel, as the respective heads compute their outputs independently of one another, in accordance with an embodiment of the present disclosure.

FIG. 15 is a portrayal of one encoder layer of a Transformer network, in accordance with an embodiment of the present disclosure.

FIG. 16 shows a schematic overview of a Transformer model, in accordance with an embodiment of the present disclosure.

FIGS. 17A and 17B is a depiction of a Vision Transformer (ViT), in accordance with an embodiment of the present disclosure.

FIG. 18A-D illustrates a processing flow of the Vision Transformer (ViT), in accordance with an embodiment of the present disclosure.

FIG. 19 shows example software code that implements a Transformer block, in accordance with an embodiment of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

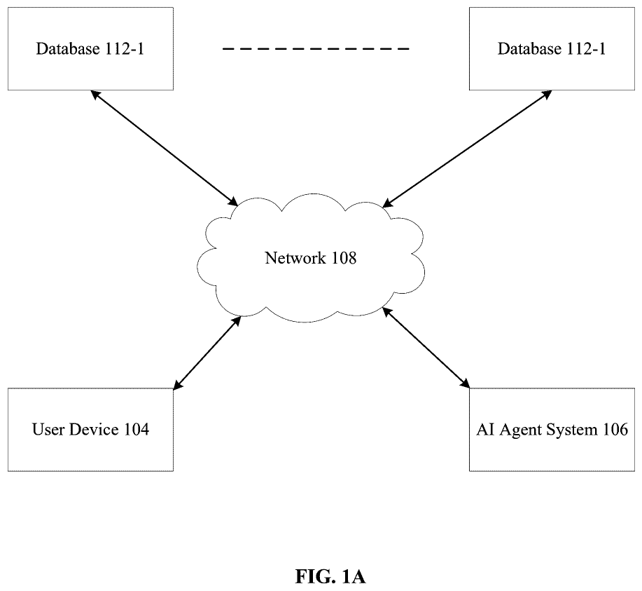

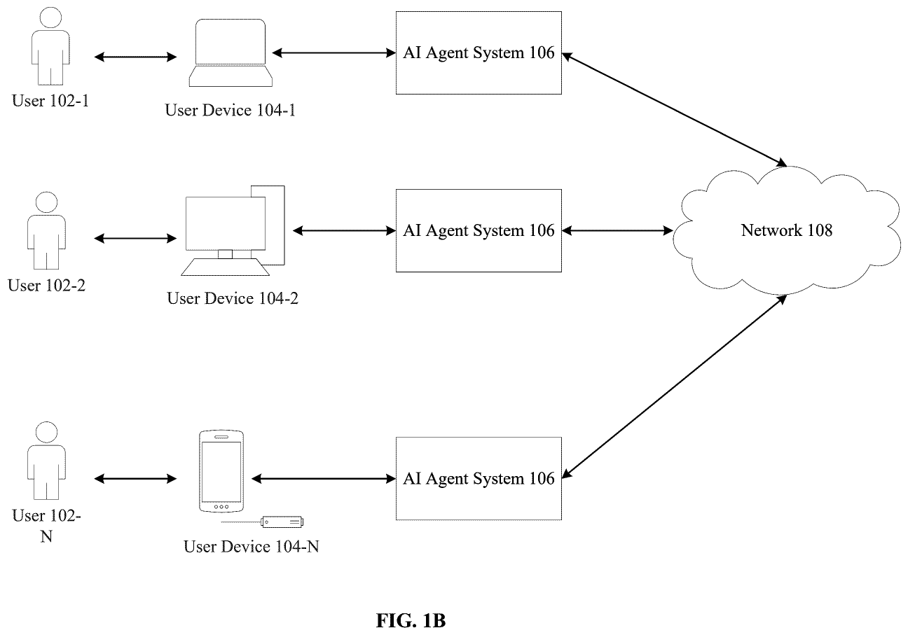

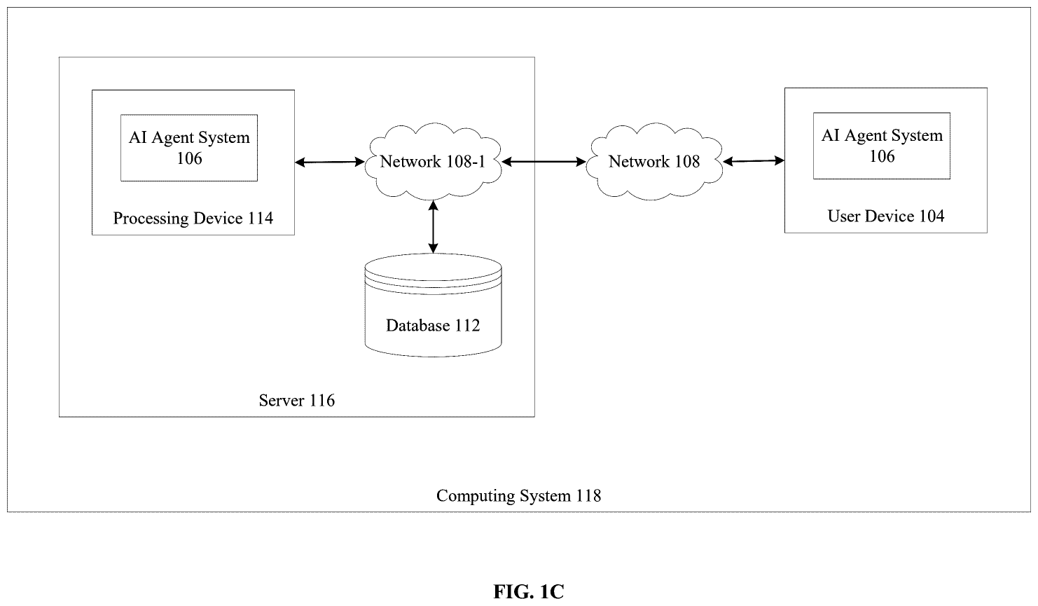

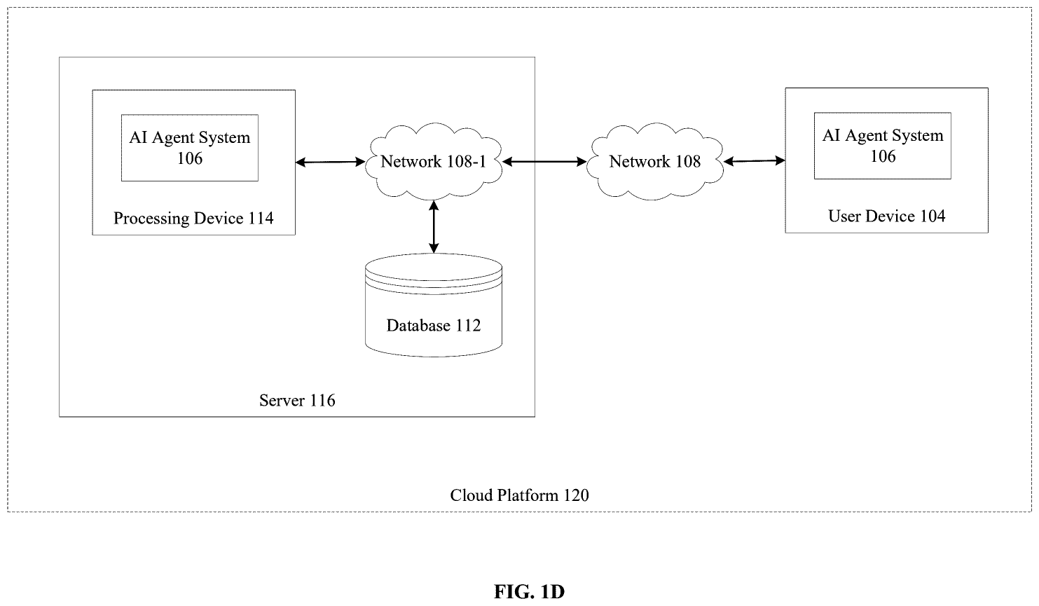

FIG. 1A shows an example network diagram 100 utilized to describe the various disclosed embodiments. In the example network diagram 100, a user device 104, an AI agent system 106, and a plurality of databases 112-1 through 112-N, hereinafter referred to individually as a database 112 and collectively as databases 112, are communicatively connected via a network 108. The network 108 may include, but is not limited to, a wireless, cellular, or wired network, a local area network (LAN), a wide area network (WAN), a metro area network (MAN), the Internet, the worldwide web (WWW), similar networks, or any combination thereof.

The user device 104 may be, but is not limited to, a personal computer, a laptop, a tablet computer, a smartphone, a wearable computing device, or any other device capable of receiving and displaying notifications. The user device 104 interacts with the AI agent system 106 through the network 108 to send user queries and receive the generated outcomes.

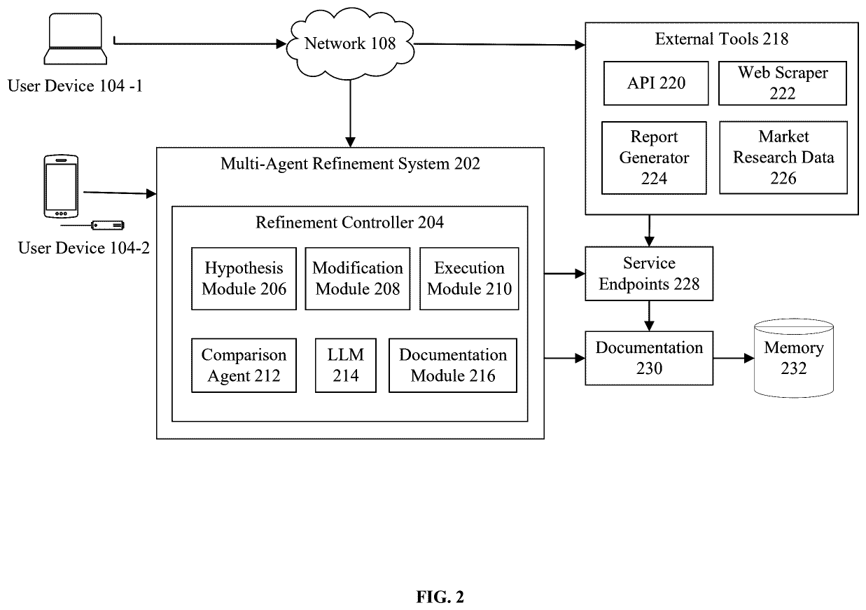

The AI agent system 106, described as a multi-agent refinement system in FIG. 2, is configured to receive and process user queries from the user device 104. Upon receiving a query, the AI agent system 106 analyzes the query, determines a sequence of tasks required to generate the desired outcome, and communicates with the appropriate databases 112-1 through 112-N to retrieve the necessary information. The AI agent system 106 may include various components such as processors, memory, and communication modules to execute these tasks and manage the interaction with the databases 112.

The databases 112-1 through 112-N store various types of data that the AI agent system 106 can access to perform the tasks necessary to respond to the user query. The databases 112 may contain text documents, images, videos, and other forms of data that are required for generating the outcome of the user query. The AI agent system 106 retrieves the data over the network 108 and processes the according to the determined sequence of tasks, generating the desired output which is then sent back to the user device 104.

FIG. 1B shows an exemplary architecture of the AI agent system 106 implementation in a network environment 110B. The network environment 100b includes users (102-1, 102-2, . . . , 102-N), enabled to operate one or more user devices (104-1, 104-2, . . . , 104-N) communicatively coupled to the AI agent system 106 through the network 108.

Users 102 represent individuals or entities that interact with the AI agent system 106 through the user devices 104. The users 102 may encompass a variety of roles within an organization or external parties that require access to, or interaction with, the AI agent system 106. Examples of the users 102 include employees within a company, customers seeking services or products, and partners or vendors involved in business operations.

In a corporate environment, employees, such as managers and data analysts, frequently interact with the AI agent system 106. Managers may query the AI agent system 106 to obtain business intelligence reports, track project statuses, or receive alerts related to key performance indicators (KPIs). For example, a marketing manager might request a summary of the latest sales trends, and the AI agent system 106 would retrieve and process relevant data from the databases 112 to generate the required report. Data analysts may utilize the AI agent system 106 to extract and analyze large datasets to identify patterns or generate predictive models. For example, a data analyst might access the system to gather customer behavior data and apply machine learning models to predict future purchasing trends. The users 102, thus, interact with the AI agent system 106 to get certain tasks performed.

The AI agent system 106 generally functions as an interface to all, or a subset of, enterprise data, information, and system functionality (e.g., via the network 108). The AI agent system 106 interacts with various components of the network 108 for accessing a variety of enterprise data and information as well as affecting change within the enterprise. The AI agent system 106 may use this enterprise data (and optionally externally available data) and information to generate a model or expand a pre-built model. The model may comprise a semantic model that ties various types of data to each other based on, for example, logic and rules, semantic relationships, and the like. The model may be monolithic or segmented/partitioned and may comprise language-specific/language-independent elements. The model may provide a description and/or map of pieces of information relevant to an enterprise and may be monolithic, or may be segmented, and may comprise language-specific and/or language-independent elements. The model may map generic or abstract concepts to real-world concepts, describe relationships within business concepts and systems, and provide an understanding of how words or terms, etc., are used, such as by a person, groups of persons, and the like. The understanding may further be classifiable to characteristics that identify a person or groups of persons and the like, such as a person's native language, a person's education, a person's current role in an enterprise, demographics of the person, and the like. In this way, understanding of how words or terms are used may be enriched even with restricted access to knowledge of a person, such as might occur when protecting personally identifying information of a person, and the like. The model may incorporate how a business or company uses terms/words and in what contexts the terms/words may be used. The model may comprise a business- and application-specific knowledge graph that the AI agent system 106 can use for general knowledge query, customer-specific master data/facts, identification/contextualization of mapped external data sources for access, as well as elements to support reasoning, disambiguation, etc.

The AI agent system 106 may generally function as an omni-channel, intelligent, proactive virtual agent with respect to the user devices 104-1 through 104-N. The AI agent system 106 may receive queries, commands, or other requests from the user devices 104-1 through 104-N via a variety of communication channels. The AI agent system 106 may use the model to respond to the queries, commands, or other requests from the user devices 104-1 through 104-N. For example, with queries, the AI agent system 106 can refer to or look to the model to obtain answers to the queries. The AI agent system 106 can also initiate communication to the user devices 104-1 through 104-N regarding workflow (e.g., initiate meeting reminders or contact user devices 104-1 through 104-N regarding the status of a project) via a variety of communication channels.

The AI agent system 106 may be used with enterprise systems of a variety of industries, e.g., aerospace, manufacturing, agriculture, shipping, oil and gas, mining, construction, etc. Embodiments of the model, such as a semantic model embodiment, may reflect the unique terminology used in a particular industry, within a particular enterprise in the industry, within a particular enterprise independent of its industry, and the like. In embodiments, the model may reflect how terms relate to each other in a hierarchy or other semantic organization, such as represented by a graph. As appreciated by one of ordinary skill in the art, the AI agent system 106 may be used with other industries, independent of use in the other industries.

The AI agent system 106 may, without limitation, provide the following functionalities: obtain answers to questions from the user devices 104-1 through 104-N about a business, such as metrics about the business, knowledge of how and where the business conducts business, information about products and services of a business, information about the market or industry of the business, information about how a business is organized, and the like, engage in conversation with users via the user devices 104-1 through 104-N, provide assistance with workflows, listen to requests from the user devices 104-1 through 104-N, take actions based on requests, initiate communication with employees of an enterprise, with customers of the enterprise (including to implement complex speech dialogs) and with others that have some relationship to the enterprise (such as contractors, prospective customers, partners, investors, board members, managers, vendors, suppliers, service providers, and many others), and the like. References to “users” of the AI agent system should be understood to encompass these and other types of users. The AI agent system 106 may initiate suggested actions to the user devices 104-1 through 104-N(e.g., the AI agent system can send a hint of suggested actions to the user devices 104-1 through 104-N).

The AI agent system 106 may be optimized over time as new amounts of data are incorporated into the model. In embodiments, the system may evolve and become smarter in terms of industry and customer knowledge, user behaviors, preferences, use of words and terms, and additional languages. This may, for example, result in faster response times, greater relevance of responses, fewer exchanges to satisfy an inquiry, and the like.

FIG. 1B, thus, shows a single network 108 between the user devices 104-1 through 104-N and the AI agent system 106, the user devices 104-1 through 104-N and the AI agent system 106 may be on the same network 108. In some embodiments, there may be multiple networks 108 between the user devices 104-1 through 104-N and the AI agent system 106 that are interconnected. The network 108 may be a private network, a public network, or a hybrid network. The network 108 may be a local area network or wide area network.

The network 108 may be connected via wired or wireless links. Wired links may include Digital Subscriber Line (DSL), coaxial cable lines, Ethernet, fiber-optic, or other links used for network infrastructure as would be understood by one of ordinary skill in the art. The wireless links may include cellular, BLUETOOTH, Wi-Fi, Worldwide Interoperability for Microwave Access (WiMAX), an infrared channel, satellite bands, or other wireless networking technologies as would be understood by one of ordinary skill in the art. The wireless links may also include any cellular network standards used to communicate among mobile devices, including standards that qualify as 1G, 2G, 3G, 4G, 5G, LTE, or the like. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, HSPA, LTE, LTE Advanced, Mobile WiMAX, and WiMAX-Advanced. Cellular network standards may use various channel access methods, e.g., FDMA, TDMA, CDMA, or SDMA. In some embodiments, different types of data may be transmitted via different links and standards. In other embodiments, the same types of data may be transmitted via different links and standards.

The network 108 may be any type and/or form of network. The geographical scope of the network 108 may vary widely and the network 108 can be a body area network (BAN), a personal area network (PAN), a local-area network (LAN), e.g., Intranet, a metropolitan area network (MAN), or a wide area network (WAN), e.g., the Internet. The topology of the network 108 may be of any form and may include, e.g., any of the following: point-to-point, serial, bus, star, ring, mesh, or tree. The network 108 may be an overlay network which is virtual and sits on top of one or more layers of other networks. The network 108 may be of any such network topology as known to those ordinarily skilled in the art capable of supporting the operations described herein. The network 108 may utilize different techniques and layers or stacks of protocols, including, e.g., the Ethernet protocol, the Internet protocol suite (e.g., TCP/IP, UDP/IP, etc.), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv6), or the link layer. The network 108 may be a type of a broadcast network, a telecommunications network, a data communication network, or a computer network.

In some implementations, one or more of users 102-1 through 102-N may access the AI agent system 106 (e.g., using one or more of user devices 104-1 through 104-N). The AI agent system 106 may include one or more user interfaces, such as browsers and textual or graphical user interfaces, through which users 102-1 through 102-N may access the AI agent system 106.

FIG. 1C is a block diagram that illustrates a first example system 100C, in accordance with some embodiments of the present disclosure. As discussed herein, the AI agent system 106 may include logic that enables the operations and systems described herein when executed. In one embodiment, system 100C may be described as a computing system 118, including means for performing the operations described herein. In one embodiment, the AI agent system 106 resides in whole or in part on a computing system 118 of the system 100C. In another embodiment, the AI agent system 106 resides in whole or in part on an edge network device, such as a user device 104-1 through 104-N of system 100C. In yet another embodiment, the AI agent system 106 resides in whole or in part on any combination of the two or in a different system entirely.

The computing system 118 may include various components, which may allow the AI agent system 106 to run on a server device or user device 104. Each component may perform different functions, operations, actions, processes, methods, etc., for the embodiments described herein and/or may provide different services, functionalities, and/or resources for the embodiments described herein. As illustrated in FIG. 1C, computing system 118 includes the AI agent system 106, a processing device 114, a database 112, and a network 108. The AI agent system 106, the processing device 114, and the database 112 may be coupled to each other via network 108. Network 108 may be a public network, a private network, or a combination thereof. In one embodiment, network 108 may include a wired or a wireless infrastructure, which may be provided by one or more wireless communications systems, such as a Wi-Fi hotspot connected with the network 108 and/or a wireless carrier system that can be implemented using various data processing equipment, communication towers, etc. The network 108 may carry communications between the various components of computing system 118. The database 112 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Each component may include hardware such as processing devices (e.g., processors, central processing units (CPUs), graphics processing units (GPUs)), memory (e.g., random access memory (RAM)), storage devices (e.g., hard-disk drive (HDD), solid-state drive (SSD), etc.), and other hardware devices (e.g., sound card, video card, etc.). The computing system 118 may comprise any suitable type of computing device or machine that has a programmable processor including, for example, server computers, desktop computers, laptop computers, tablet computers, smartphones, set-top boxes, etc. In some examples, the computing system 118 may comprise a single machine or may include multiple interconnected machines (e.g., multiple servers configured in a cluster). The computing system 118 may be implemented by a common entity/organization or may be implemented by different entities/organizations.

FIG. 1D is a block diagram that illustrates a second example system 100D, in accordance with some embodiments of the present disclosure. System 100D includes a cloud platform 120, which may include one or more components. As discussed herein, AI agent system 106 may include logic that enables the operations and systems described herein when executed. In one embodiment, system 100D may be described as a cloud platform 120, including means for performing the operations described herein (e.g., server 116, network 108, user device 104, etc.). In one embodiment, AI agent system 106 resides in whole or in part on a server (e.g., server 116) of system 100D. In another embodiment, AI agent system 106 resides in whole or in part on a user device (e.g., user device 104) of system 100D. In yet another embodiment, AI agent system 106 resides in whole or in part on any combination of the two or in a different system entirely.

Server 116 may include various components, which may allow AI agent system 106 to run on a server device or user device 104. Each component may perform different functions, operations, actions, processes, methods, etc., for the embodiments described herein and/or may provide different services, functionalities, and/or resources for the embodiments described herein.

As illustrated in FIG. 1D, server 116 includes an AI agent system 106, a processing device 114, a database 112, and a network 108. The AI agent system 106, the processing device 114, and the database 112 may be coupled to each other via network 108. Network 108 may be a public network, a private network, or a combination thereof. In one embodiment, network 108 may include a wired or a wireless infrastructure, which may be provided by one or more wireless communications systems, such as a Wi-Fi hotspot connected with the network 108 and/or a wireless carrier system that can be implemented using various data processing equipment, communication towers, etc.

The network 108 may carry communications between the various components of server 116. The database 112 may be a persistent storage that is capable of storing data. Persistent storage may be a local storage unit or a remote storage unit. Persistent storage may be a magnetic storage unit, optical storage unit, solid-state storage unit, electronic storage units (main memory), or a similar storage unit. Persistent storage may also be a monolithic/single device or a distributed set of devices.

Each component may include hardware such as processing devices (e.g., processors, central processing units (CPUs), graphics processing units (GPUs)), memory (e.g., random access memory (RAM)), storage devices (e.g., hard-disk drive (HDD), solid-state drive (SSD), etc.), and other hardware devices (e.g., sound card, video card, etc.). The server 116 may comprise any suitable type of computing device or machine that has a programmable processor including, for example, server computers, desktop computers, laptop computers, tablet computers, smartphones, set-top boxes, etc. In some examples, the server 116 may comprise a single machine or may include multiple interconnected machines (e.g., multiple servers configured in a cluster). The server 116 may be implemented by a common entity/organization or may be implemented by different entities/organizations.

In one embodiment, server 116 is operably connected to user device 104 via network 108. Network 108 may be a public network, a private network, or a combination thereof. In one embodiment, network 108 may include a wired or a wireless infrastructure, which may be provided by one or more wireless communications systems, such as a Wi-Fi hotspot connected with the network 108 and/or a wireless carrier system that can be implemented using various data processing equipment, communication towers, etc. The network 108 may carry communications between the various components of system 100D. User device 104 may include AI agent system 106, in addition to, or alternatively from, server 116.

### System Architecture

FIG. 2 illustrates a high-level architecture of a multi-agent refinement environment, alternatively referred to as a multi-agent refinement system 202. The multi-agent refinement system 202 is communicatively coupled to a network 108 and to one or more user endpoints, shown as a user device 104-1 and a user device 104-2. The user device 104-1 and the user device 104-2 are operable to provide configuration data defining a plurality of artificial intelligence (AI) agents having predefined roles, goals, and workflows and to receive outputs generated by executions of such AI agents. The network 108 denotes any suitable communication fabric (for example, the Internet, an intranet, a VPN, or a cellular data network) through which requests and responses are exchanged with the multi-agent refinement system 202 using standard protocols and authenticated sessions.

The multi-agent refinement system 202 includes a refinement controller 204. The refinement controller 204 is a computing component implemented in software, firmware, hardware, or combinations thereof, and coordinates operations for receiving configuration data defining the plurality of AI agents having predefined roles, goals, and workflows; executing the plurality of AI agents to perform tasks based on the configuration data to generate an output; evaluating, using a LLM as described below, the output against evaluation criteria; generating a hypothesis for modifying at least one of the roles, workflows, or inter-agent dependencies based on the evaluation; and implementing a modified configuration of the plurality of AI agents according to the hypothesis to produce a modified output. In one non-limiting arrangement, receiving configuration data includes ingesting role specifications (for example, textual role descriptions and prompts), agent goal definitions (for example, task objectives and success conditions), and workflow artifacts (for example, dependency graphs and execution orderings) that collectively define how the plurality of AI agents will be initialized and orchestrated.

Executing the plurality of AI agents to perform tasks based on the configuration data to generate an output includes launching agent processes or threads, allocating compute resources, honoring the predefined roles, goals, and workflows, and returning the output in a machine-readable form suitable for subsequent evaluation. Evaluating, using a large language model as described below, the output against evaluation criteria includes supplying the output to the large language model together with evaluation criteria so that the large language model scores, ranks, or analyzes the output in view of the evaluation criteria. Generating a hypothesis for modifying at least one of the roles, workflows, or inter-agent dependencies based on the evaluation includes formulating a concrete proposed change, such as revising a role description, altering a workflow step, or changing an inter-agent dependency, to address deficiencies or opportunities identified during the evaluating. Implementing a modified configuration of the plurality of AI agents according to the hypothesis to produce a modified output includes applying the proposed change to the configuration data, updating the relevant role, workflow, or inter-agent dependency, re-executing the plurality of AI agents under the modified configuration, and producing the modified output for comparison with prior results.

In various configurations, the refinement controller 204 exposes programmatic interfaces to the user device 104-1 and the user device 104-2 for uploading configuration data, supplying an idea description from which initial roles, workflows, and dependencies may be inferred, initiating executions, and retrieving outputs and logs. Exposing programmatic interfaces includes providing authenticated endpoints for create, read, update, and execution operations, receiving uploads that contain the configuration data, accepting an idea description that serves as input to infer the initial roles, workflows, and inter-agent dependencies, issuing control commands to initiate executions of the plurality of AI agents, and returning outputs and logs to the user device 104-1 and the user device 104-2 for inspection and recordkeeping. The refinement controller 204 may be realized as a single service, a set of microservices deployed on container infrastructure, or a distributed application spanning multiple compute instances, without departing from its coordinated behavior recited above. Realizing the refinement controller 204 as a single service includes hosting all coordination logic within one executable process. Realizing the refinement controller 204 as a set of microservices deployed on container infrastructure includes packaging discrete coordination functions into separate containers that communicate over service interfaces. Realizing the refinement controller 204 as a distributed application spanning multiple compute instances includes partitioning coordination responsibilities across multiple machines for scalability and fault tolerance, while preserving the coordinated behavior of receiving configuration data, executing the plurality of AI agents to generate an output, evaluating the output against evaluation criteria using a large language model, generating a hypothesis based on the evaluation, and implementing a modified configuration to produce a modified output.

The refinement controller 204 is operatively connected to an LLM 214. The LLM 214 is configured to generate qualitative and quantitative evaluation criteria, to evaluate outputs against the evaluation criteria, and to supply analyses used by the refinement controller 204 to generate the hypothesis for modifying roles, workflows, or inter-agent dependencies. In one arrangement, the operative connection between the refinement controller 204 and the LLM 214 includes authenticated request-response calls in which the refinement controller 204 transmits an output and a current set of evaluation criteria to the LLM 214 and receives a structured evaluation that includes scores, rationales, and recommended areas for improvement. In another arrangement, the operative connection includes a streaming interface that allows partial outputs to be evaluated incrementally, thereby enabling the refinement controller 204 to gather early signals for hypothesis formation. As used herein, “evaluation criteria” include, without limitation, clarity, relevance, completeness, depth of analysis, actionability, consistency, execution time, and success rate.

Clarity denotes the degree to which the output is understandable to an intended consumer, relevance denotes the degree to which the output addresses the specified goals, completeness denotes whether required components are present; depth of analysis denotes the extent of reasoning or substantiation; actionability denotes whether the output yields concrete next steps, consistency denotes alignment across sections or agents; execution time denotes latency measurements associated with generating the output; and success rate denotes a rate at which tasks complete without failure. The LLM 214 is further operable to analyze an idea description to infer initial roles, workflows, and dependencies for initializing the plurality of AI agents. In an example, the LLM 214 parses an idea description to identify constituent sub-tasks, allocates those sub-tasks to roles with corresponding goals, and emits a workflow graph that identifies the inter-agent dependencies required to accomplish the sub-tasks in a coherent sequence.

In different implementations, the LLM 214 is an external model endpoint, a locally hosted model accelerated by specialized hardware, or an embedded model instance co-resident with the refinement controller 204. When implemented as an external model endpoint, the LLM 214 is accessed over the network 108 using secure APIs and rate-limited invocation policies; when implemented as a locally hosted model, the LLM 214 executes on GPU- or accelerator-enabled servers under control of the multi-agent refinement system 202; and when implemented as an embedded model instance co-resident with the refinement controller 204, the LLM 214 shares memory and scheduling resources with the refinement controller 204 to reduce latency while preserving the configured evaluation behavior.

In one embodiment, the refinement controller 204 is configured for evaluating the output. The evaluation of the output comprises analyzing, by the LLM 214 under coordination of the refinement controller 204, a depth of analysis relative to agent goals and task objectives and determining whether the output provides actionable insights aligned with system objectives. The refinement controller 204 supplies the LLM 214 with the output, a goal/task manifest for contributing agents, and the active evaluation criteria. The LLM 214 (i) scores depth by checking granularity, evidentiary support, cross-references, and multi-step reasoning against the declared goals/objectives, and (ii) scores actionability by verifying that recommended next steps are concrete, attributable, time-bound, and mapped to system objectives. The LLM 214 returns per-criterion scores with brief rationales and targeted remediation suggestions, which the refinement controller 204 records and forwards to hypothesis generation for subsequent modification.

The refinement controller 204 interfaces with a hypothesis module 206. The hypothesis module 206 produces one or more hypotheses that describe structural changes to agent roles, workflows, or inter-agent dependencies in view of the evaluation provided via the LLM 214. In operation, the hypothesis module 206 receives the structured evaluation (including scores, rationales, and identified deficiencies) and maps that evaluation to concrete, testable proposals for change. A hypothesis may specify, by way of example, adding a retrieval agent to enrich context before analysis, re-ordering a workflow so that verification precedes reporting, changing a dependency edge between two agents to tighten quality gating, altering tool bindings of an agent to incorporate a different API 220, or revising a role definition to analyse depth of analysis in intermediate findings.

Each hypothesis is represented in machine-readable form so that it can be applied deterministically to configuration data that defines the plurality of AI agents. The hypothesis module 206 may score or prioritize hypotheses based on predicted impact derived from historical evaluation data and may emit rationales suitable for documentation. Predicted impact can be computed from prior correlations between specific change types and observed improvements in clarity, relevance, completeness, depth of analysis, actionability, consistency, execution time, or success rate. The hypothesis module 206 supplies a ranked list of hypotheses to the refinement controller 204 together with rationales, enabling downstream selection, implementation, and documentation by the modification module 208 and the documentation module 216.

The refinement controller 204 further interfaces with a modification module 208. The modification module 208 synthesizes a modified configuration of the plurality of AI agents by applying a selected hypothesis to agent logic, roles, tasks, and workflows. In operation, the modification module 208 receives a selected hypothesis from the refinement controller 204 and edits configuration data to reflect the proposed change without ambiguity. Editing configuration data includes updating prompts that define roles, revising code modules that implement tasks, rebinding tool connectors associated with specific agents, and rewriting workflow and dependency graphs so that inter-agent dependencies are consistent with the selected hypothesis. In some configurations, the modification module 208 generates a plurality of modified configurations from a set of hypotheses so that multiple variants can be executed in parallel. Generating a plurality of modified configurations includes producing distinct configuration versions in which each version corresponds to a single hypothesis or a controlled combination of hypotheses, thereby enabling parallel exploration of alternatives. The modification module 208 maintains version identifiers for each configuration, records changes at the level of prompts, code, tool connectors, and dependency graphs, and validates that a configuration is executable prior to hand-off to execution. Validation includes static checks that required roles, goals, and workflows are present, graph checks that dependencies are acyclic and resolvable, and tool checks that bound services such as the API 220 are reachable with current credentials. Upon successful validation, the modification module 208 registers each modified configuration with the refinement controller 204 for scheduling by the execution module 210 and persists the configuration artifacts in the memory 232 so that subsequent comparison and documentation stages can reference the exact configuration that produced a given modified output.

An execution module 210 is provided to run the configuration (including the modified configuration), gather outputs, and return execution diagnostics suitable for subsequent evaluation. In one arrangement, the execution module 210 receives from the refinement controller 204 an identifier of a configuration (for example, a baseline configuration or a modified configuration synthesized by the modification module 208) and a run specification indicating scheduling mode and resource constraints. Running the configuration includes instantiating the plurality of AI agents as processes or tasks, wiring inter-agent dependencies according to the workflow graph, and invoking bound services in external tools 218, for example, the API 220, the web scraper 222, the report generator 224, the market research data 226, and the service endpoints 228, as declared by the configuration. The execution module 210 may schedule runs sequentially or concurrently. Sequential scheduling executes a single configuration at a time to conserve resources and to simplify debugging, whereas concurrent scheduling executes multiple configurations in parallel to increase throughput during variant exploration. The execution module 210 enforces timeouts and resource limits, such as maximum wall-clock time, CPU/GPU quotas, memory ceilings, and concurrency caps per tool connector, to ensure fair usage and to prevent runaway tasks. The execution module 210 performs debugging of agent interactions by collecting traces, for example, inter-agent message payloads, timing information, and tool-call metadata, and error logs, for example, exception stacks and failed tool invocations. Gathering outputs includes collecting final artifacts produced by the configuration, for example, generated texts, structured data files, or reports, and associating those artifacts with execution diagnostics and a configuration version identifier so that subsequent evaluation can reproduce the context of generation. The execution module 210 exposes outputs and diagnostics to the refinement controller 204 and to the evaluation and comparison components described herein by emitting machine-readable records that reference configuration identifiers, agent identifiers, tool-call identifiers, and timestamps, thereby enabling deterministic linkage between the executed configuration and its outputs.

A comparison agent 212 compares outputs generated by modified configurations against a best-known output to determine a top-performing variant. In operation, the comparison agent 212 retrieves, either directly or via the refinement controller 204, the best-known output and its associated configuration and assembles a candidate set comprising outputs from one or more modified configurations produced by the execution module 210. The comparison agent 212 supports pairwise or rank-based scoring relative to the best-known output. Pairwise scoring evaluates each candidate output against the best-known output using the evaluation criteria to produce a comparative score; rank-based scoring orders multiple candidate outputs and the best-known output on a common scale to identify the highest-scoring item. The comparison agent 212 may employ combined qualitative-quantitative scoring derived from the evaluation criteria, for example, clarity, relevance, completeness, depth of analysis, actionability, consistency, execution time, and success rate, and may apply tie-breaking rules, for example, favoring lower execution time when combined scores are equal, to ensure a determinate result. The comparison agent 212 supplies a comparison result that is used by the refinement controller 204 to decide whether to update the best-known output and its associated configuration. The comparison agent 212 operates as a stage separate from the updating action to maintain a clear separation between comparing and updating. Separating the comparing stage from the updating action ensures that the act of determining a top-performing variant (by producing a comparison result) is logically and temporally distinct from the act of persisting a new best-known output, thereby preserving traceability and enabling downstream auditing of selection decisions.

A documentation module 216 records successful and failed configurations with associated hypothesis, matrices configuration modifications, evaluation results, ranking decisions, and rationales, thereby generating documentation suitable for traceability and reproducibility. In use, the documentation module 216 receives, from the refinement controller 204 and related components, the artifacts of each iteration, including (i) the hypothesis generated from the evaluation performed using the LLM 214; (ii) the exact configuration modifications applied by the modification module 208 (for example, role edits, workflow re-orderings, dependency-edge changes, and tool-binding updates); (iii) the evaluation results for each output, including per-criterion scores and narrative rationales; (iv) the ranking decisions and the comparison result emitted by the comparison agent 212; and (v) the selection decision made by the refinement controller 204 regarding whether to update the best-known output and its associated configuration.

The documentation module 216 may persist machine-readable logs (for example, structured records keyed by configuration version identifiers and execution identifiers), human-readable summaries (for example, narrative explanations describing rationale, context, and expected improvement for an implemented modification), and cross-references to configuration versions and outputs so that any iteration can be reconstructed. Persisting such documentation enables end-to-end traceability from an idea description or configuration upload through execution, evaluation, hypothesis generation, modification, comparison, and selection, and supports reproducibility by allowing a subsequent process to re-run a specific configuration with the same tool bindings and workflow graph while verifying that the outputs and evaluation results match those recorded.

In one embodiment suitable for FIG. 2, the multi-agent refinement system 202 is further configured to run and debug multiple configurations, assess agent outputs using predefined or llm-generated qualitative metrics and provide feedback, synthesize new configurations based on hypotheses, and compare outputs from modified configurations against a best-known output to determine a top-performing variant. The execution module 210 receives a set of configuration identifiers registered by the refinement controller 204 and runs the corresponding configurations sequentially or in parallel. During each run, the execution module 210 instantiates the plurality of ai agents, enforces resource and timeout policies, and performs debugging of agent interactions by collecting traces, tool-call metadata, and error logs so that faults can be localized to specific roles, workflow edges, or tool connectors. Outputs and execution diagnostics from each configuration are emitted as machine-readable records and persisted for downstream evaluation.

The multi-agent refinement system 202 integrates external tools 218. The external tools 218 include, by way of example, an API 220, a web scraper 222, a report generator 224, market research data 226, and service endpoints 228. The external tools 218 are invoked during execution for information retrieval, report generation, validation, or domain-specific enrichment used by the plurality of AI agents and by the refinement controller 204. The API 220 represents one or more HTTP or RPC interfaces to third-party or enterprise services. The web scraper 222 retrieves structured or semi-structured information from web resources where permitted. The report generator 224 formats and exports outputs into deliverables. The market research data 226 denotes datasets used to validate or supplement findings. The service endpoints 228 include analytics or verification services against which outputs may be checked.

The architecture further shows the documentation 230 and the memory 232. The documentation 230 denotes a repository or log facility written by the documentation module 216 and stores successful and failed configurations of each refinement cycle, including hypotheses, configuration changes, evaluations, comparison outcomes, and selection decisions. In one configuration, the documentation 230 is implemented as a write-optimized log store that accepts structured records keyed by iteration identifiers and configuration version identifiers, so that each hypothesis, each configuration change (for example, role edit, workflow re-ordering, dependency-edge update, or tool-binding change), each evaluation (including per-criterion scores and narrative rationales), each comparison outcome (pairwise or rank-based), and each selection decision can be traced in time order. In another configuration, the documentation 230 maintains both machine-readable logs (for programmatic replay) and human-readable summaries (for audit and review), with cross-references to specific artifacts persisted in the memory 232. The documentation module 216 appends to the documentation 230 at well-defined points in the flow, upon hypothesis creation, upon configuration synthesis by the modification module 208, upon completion of execution by the execution module 210, upon evaluation using the LLM 214, upon emission of a comparison result by the comparison agent 212, and upon a selection decision by the refinement controller 204, so that any iteration can be reconstructed deterministically.

The documentation 230 denotes a repository or log facility written by the documentation module 216 and stores artifacts of each refinement cycle, including hypotheses, configuration changes, evaluations, comparison outcomes, and selection decisions. In one configuration, the documentation 230 is implemented as a write-optimized log store that accepts structured records keyed by iteration identifiers and configuration version identifiers, so that each hypothesis, each configuration change (for example, role edit, workflow re-ordering, dependency-edge update, or tool-binding change), each evaluation (including per-criterion scores and narrative rationales), each comparison outcome (pairwise or rank-based), and each selection decision can be traced in time order. In another configuration, the documentation 230 maintains both machine-readable logs (for programmatic replay) and human-readable summaries (for audit and review), with cross-references to specific artifacts persisted in the memory 232. The documentation module 216 appends to the documentation 230 at well-defined points in the flow, upon hypothesis creation, upon configuration synthesis by the modification module 208, upon completion of execution by the execution module 210, upon evaluation using the LLM 214, upon emission of a comparison result by the comparison agent 212, and upon a selection decision by the refinement controller 204, so that any iteration can be reconstructed deterministically.

The memory 232 denotes storage for configurations and outputs, including a best-known output and its associated configuration. In one illustration, the memory 232 includes a relational catalog that stores configuration metadata, for example, version id, parent version id, timestamps, originating hypothesis id, and active evaluation-criteria snapshot, and an object store that persists configuration payloads, for example, prompts, code modules, workflow graphs, and tool-connector settings, together with generated outputs, for example, text reports, structured result files, or intermediate artifacts. In another illustration, the memory 232 comprises a key-value store for fast retrieval of the current best-known pointers, for example, keys “best output” and “best configuration” referencing immutable objects, a document index that enables semantic or attribute-based retrieval of prior configurations, for example, all configurations that altered a dependency between two specified agents, and a checksum registry that records content hashes for provenance and integrity verification. The memory 232 may be deployed on a single server with local disks, in a cloud environment using managed database and object-storage services, or in a hybrid arrangement in which sensitive artifacts are retained on-premises while non-sensitive metadata is hosted in the cloud.

The memory 232 also supports retrieval of prior best performing agent configurations and their respective outputs so that a referenced output can be compared against a newly generated output in subsequent iterations. For example, the refinement controller 204 may request the configuration and output associated with a specific hypothesis to perform a targeted A/B comparison against a newly generated variant; the memory 232 returns the exact configuration payload (prompts, code, workflow graph, and tool bindings) and the corresponding output artifact, enabling the comparison agent 212 to compute pairwise scores using the active evaluation criteria. In another example, the execution module 210 stores execution diagnostics (timings, error traces, tool-call metadata) alongside outputs; these diagnostics are retrieved with the output to inform re-execution or debugging. The memory 232 may maintain retention policies (for example, retain all best-known artifacts indefinitely, retain non-selected variants for a fixed horizon, and retain summaries after raw artifacts are archived), snapshot mechanisms (for example, periodic snapshots of evaluation-criteria sets and dependency graphs), and access controls (for example, role-based access to sensitive outputs) to support enterprise operation. Caching layers may be employed to accelerate frequent reads of the best-known output and configuration, while background archival processes move seldom-accessed artifacts to lower-cost storage without altering the identifiers used by the refinement controller 204, the comparison agent 212, the execution module 210, or the documentation module 216.

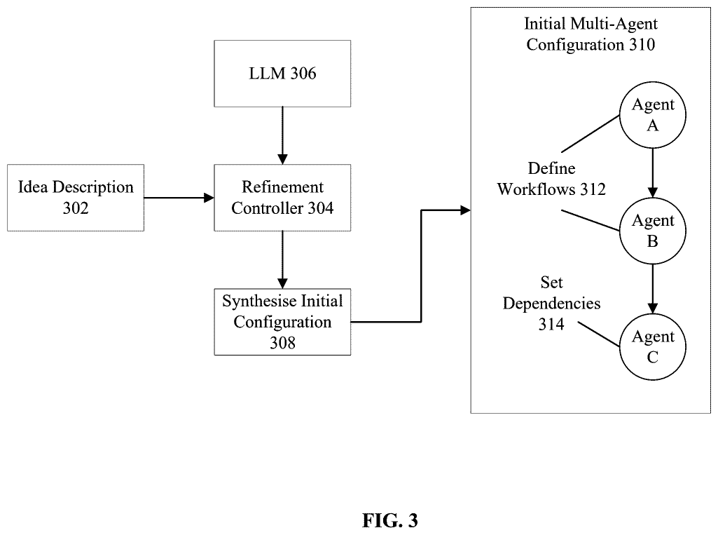

FIG. 3 illustrates initialization from idea description for a multi-agent system. The figure depicts an input idea description 302 that is analyzed under control of a refinement controller 304 with assistance from an LLM 306 to produce an initial multi-agent configuration 310, together with explicit workflow and dependency specifications generated by synthesise initial configuration 308, define workflows 312, and set dependencies 314.

The idea description 302 denotes a free-form or structured statement of objectives, constraints, and desired outcomes from which agent roles, agent goals, workflows, and inter-agent dependencies are inferred. In practice, the idea description 302 can be a natural-language brief (for example, “produce a market landscape with sources and a one-page executive summary”), a semi-structured template (for example, JSON fields identifying required sections, data sources, and timing), or a mixture of text and parameters received from a user device. The content of the idea description 302 need not prescribe agents explicitly; rather, it provides sufficient intent for downstream inference.

The refinement controller 304 is a coordination component that receives the idea description 302, orchestrates analysis using the LLM 306, and manages the creation of artifacts shown in FIG. 3. Upon receipt of the idea description 302, the refinement controller 304 prepares prompts and context that describe the target domain and the expected granularity of outputs, invokes the LLM 306, and collects structured inferences that are used by synthesise initial configuration 308, define workflows 312, and set dependencies 314. The refinement controller 304 records the resulting artifacts so that the initialization step is reproducible and auditable.

The LLM 306 is configured to analyze the idea description 302 and to infer (i) candidate agent roles with role prompts or specifications, (ii) high-level goals aligned to the stated objectives, (iii) workflows describing execution order and data/control handoff, and (iv) inter-agent dependencies indicating which agent consumes, validates, or gates the outputs of another agent. In one illustration, the LLM 306 extracts sub-tasks such as “retrieve external data,” “synthesize findings,” and “produce final report,” associates each sub-task with a role, and emits structured suggestions that drive the modules (308, 312, and 314). The LLM 306 can also emit rationales for each inference (for example, why a verification step is required before reporting), which the refinement controller 304 preserves as part of the initialization record.

The synthesise initial configuration 308 block converts the inferences from the LLM 306 into a concrete initial multi-agent configuration 310. The initial multi-agent configuration 310 is a machine-readable specification containing agent definitions, prompts, tool bindings (if any), resource settings, and execution policies sufficient to execute a first pass without manual tuning. As depicted, the initial multi-agent configuration 310 includes agent A, agent B, and agent C to illustrate three example roles created from the idea description 302; additional agents may be synthesized when the idea description 302 indicates broader scope. For example, agent A can be a retrieval role configured to query external sources, agent B can be an analysis role configured to synthesize and rank findings, and agent C can be a reporting role configured to assemble the final deliverable.

The define workflows 312 block specifies the ordering and coordination of the agents in the initial multi-agent configuration 310. Define workflows 312 generates a workflow graph that sequences agent A, agent B, and agent C and identifies when agents execute serially or in parallel. Examples include a serial pipeline in which agent A produces a structured dossier consumed by agent B before agent C formats a report, or a branched flow in which agent A and agent B run concurrently to gather complementary evidence before agent C merges results. The outputs of define workflows 312 are stored as an explicit workflow artifact associated with the initial multi-agent configuration 310.

The set dependencies 314 block establishes inter-agent dependencies for data and quality gating. Set dependencies 314 declares, for each edge in the workflow, the expected inputs, pre-conditions, and acceptance checks. Examples include a dependency from agent A to agent B that requires a minimum number of sources and a relevance score threshold, and a dependency from agent B to agent C that requires completeness and consistency checks to pass. These dependency declarations allow the refinement controller 304 to enforce ordering and to detect unmet pre-conditions at run time.

The initial multi-agent configuration 310 is the output of the initialization pathway of FIG. 3 and serves as the baseline from which subsequent refinement cycles operate. Because agent roles, workflows, and inter-agent dependencies are all derived from the idea description 302 via the LLM 306 and rendered by synthesise initial configuration 308, define workflows 312, and set dependencies 314 under control of the refinement controller 304, the figure provides explicit support for initialization from an idea description by analyzing the idea description with an LLM to infer roles, workflows, and inter-agent dependencies and to produce an executable initial multi-agent configuration.

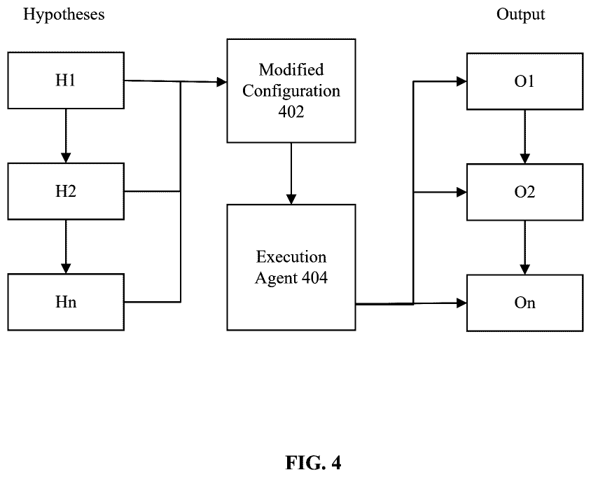

FIG. 4 illustrates variant synthesis and parallel execution in a multi-agent refinement environment and depicts how multiple hypotheses lead to multiple modified configurations that are executed concurrently to produce corresponding outputs. As shown, a refinement controller generates a plurality of hypotheses H1 . . . Hn, a modification module implements a plurality of modified configurations C1 . . . Cn according to respective hypotheses, and an execution agent 404 runs each modified configuration in parallel to obtain outputs O1 . . . On together with execution diagnostics.

The hypotheses H1 . . . Hn represent discrete, testable proposals for modifying at least one of the roles, workflows, or inter-agent dependencies of a baseline configuration. Each hypothesis specifies a concrete structural change, such as (i) inserting a retrieval role before analysis to improve completeness, (ii) re-ordering workflow steps so that verification precedes reporting to improve consistency, (iii) changing a dependency edge so that a synthesis role gates a reporting role to increase actionability, or (iv) rebinding a tool connector to an API 220 to reduce execution time. The hypotheses are produced from prior evaluation results (for example, per-criterion scores and rationales generated using an LLM 214) so that each proposal is aligned with observed deficiencies or opportunities.

The modified configurations C1 . . . Cn are synthesized by applying the respective hypotheses H1 . . . Hn to agent logic, roles, tasks, and workflows. For each Ci, the modification module edits prompts, updates code modules, adjusts workflow graphs, and rewrites dependency edges so that the plurality of artificial intelligence (AI) agents is concretely reconfigured according to the corresponding hypothesis Hi. Each Ci is versioned, validated for executability (for example, dependency graph acyclicity and tool availability), and registered with the refinement controller for scheduling. In one example, C1 adds a verification role and associated dependency edge, C2 re-orders two workflow steps, and C3 replaces a data source binding with a different API 220; additional configurations C4 . . . Cn may combine compatible proposals where appropriate.

The execution agent 404 executes the plurality of modified configurations C1 . . . Cn in parallel to obtain corresponding outputs O1 . . . On. Running each configuration includes instantiating the reconfigured plurality of AI agents, enforcing declared resource limits and timeouts, and orchestrating inter-agent messaging according to the workflow and dependency graphs embedded in the respective Ci. The execution agent 404 debugs agent interactions by collecting traces and error logs, and gathers outputs and execution diagnostics for each configuration so that subsequent evaluation and comparison can be performed deterministically. Parallel execution increases throughput of the exploration process and enables contemporaneous measurement of execution time and success rate across variants under similar operating conditions.

Each output Oi (for i∈{1 . . . n}) is the artifact produced by executing the corresponding modified configuration Ci. An output Oi can include, for example, a structured analysis, a synthesized report, or a machine-readable dataset, along with execution diagnostics such as latencies and error traces. The execution agent 404 exposes O1 . . . On and their associated diagnostics to the refinement controller and to downstream components (for example, an evaluation agent 168 for scoring against evaluation criteria and a comparison agent 212 for determining a top-performing variant relative to a best-known output). By depicting hypotheses H1 . . . Hn, modified configurations C1 . . . Cn, parallel execution by the execution agent 404, and outputs O1 . . . On, FIG. 4 provides explicit support for generating, by the refinement controller, a plurality of hypotheses; implementing, by the refinement controller, a plurality of modified configurations according to respective hypotheses; and executing the plurality of modified configurations in parallel to obtain corresponding outputs, with the execution agent 404 responsible for running, debugging, and gathering outputs for subsequent evaluation and comparison.

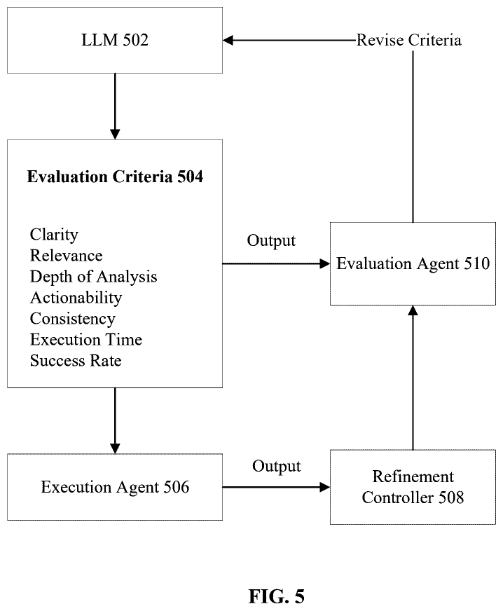

FIG. 5 illustrates LLM-generated evaluation criteria and the application of such criteria within a refinement environment. As depicted, an LLM 502 produces evaluation criteria 504 and supplies the evaluation criteria 504 to an evaluation agent 510 for scoring one or more output artifacts generated under coordination of a refinement controller 508 and executed by an execution agent 506. A revise criteria loop indicates that the LLM 502 updates the evaluation criteria 504 across iterations based on observed performance trends and changing objectives.

The LLM 502 is configured to generate qualitative and quantitative measures that define how an output is to be assessed. The evaluation criteria 504 include, without limitation, clarity, relevance, depth of analysis, actionability, consistency, execution time, and success rate. In operation, the LLM 502 may also specify per-criterion definitions, target thresholds, and aggregation rules (for example, a combined score computed from weighted per-criterion scores) so that evaluations are standardized and reproducible. The refinement controller 508 obtains the evaluation criteria 504 from the LLM 502, associates a criteria snapshot with a current iteration, and provides the criteria snapshot to the evaluation agent 510.

The evaluation agent 510 applies the evaluation criteria 504 to each output produced by the execution agent 506. Applying the evaluation criteria 504 includes determining per-criterion scores, generating rationales explaining the scores, and emitting a structured evaluation record that the refinement controller 508 uses for subsequent hypothesis generation and configuration changes. For quantitative measures such as execution time and success rate, the evaluation agent 510 may rely on execution diagnostics captured by the execution agent 506; for qualitative measures such as clarity, relevance, depth of analysis, actionability, and consistency, the evaluation agent 510 may invoke the LLM 502 to perform assisted scoring consistent with the evaluation criteria 504.

The refinement controller 508 maintains a closed evaluation loop by initiating a revise criteria interaction with the LLM 502. In this interaction, the refinement controller 508 provides summaries of recent scoring distributions, examples of output artifacts, and any updated objectives. The LLM 502 then revises the evaluation criteria 504, such as reweighting actionability, tightening thresholds for relevance, or refining guidance for depth of analysis, and returns an updated criteria set for use by the evaluation agent 510 in subsequent iterations. Prior criteria snapshots and corresponding evaluation records are preserved to ensure traceability and comparability across runs.

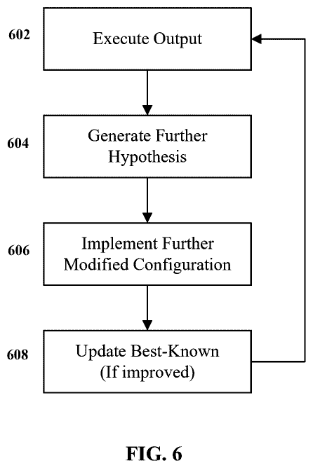

FIG. 6 illustrates comparison against a best-known configuration within an iterative refinement flow. The figure depicts four distinct stages designated as execute output 602, generate further hypothesis 604, implement further modified configuration 606, and update best-known, if improved, 608.

In operation, execute output 602 denotes running a current configuration or a modified configuration under coordination of a refinement controller 204 and an execution module 210 (or an execution agent 404, as depicted elsewhere). The execution produces a subsequent output together with execution diagnostics. The subsequent output is evaluated against evaluation criteria 504 generated by an LLM 502, and the resulting scores and rationales are supplied for downstream decision-making.

The generate further hypothesis 604 stage denotes deriving a new, concrete proposal for change based on the evaluation of the subsequent output. A hypothesis module 206 formulates the further hypothesis to address observed deficiencies or to exploit opportunities surfaced by the evaluation; examples include revising a role prompt, re-ordering a workflow step, altering an inter-agent dependency, or rebinding a tool connector to an external service.

The implement further modified configuration 606 stage denotes applying the further hypothesis to synthesize an executable configuration variant. A modification module 208 edits prompts, code modules, workflow graphs, and dependency edges to yield a further modified configuration that is validated and versioned prior to the next execution at 602.

Between the implement stage 606 and the update stage 608, a comparison agent 212 compares the subsequent output produced at 602 to a best-known output stored in memory 232, using the evaluation criteria 504 (for example, clarity, relevance, depth of analysis, actionability, consistency, execution time, and success rate). The comparison agent 212 performs pairwise or rank-based scoring and emits a comparison result without altering stored baselines, thereby maintaining a strict separation between comparing and updating.

The update best-known (if improved) 608 stage denotes an action performed by the refinement controller 204 only when the comparison result shows improvement according to a combined qualitative-quantitative score. In that event, the refinement controller 204 updates the best-known output and its associated configuration in memory 232 by advancing stored pointers or version identifiers while preserving prior best-known references for traceability. When no improvement is demonstrated, the refinement controller 204 withholds updating and the flow proceeds to another iteration beginning at execute output 602, with any termination checks (for example, thresholds on improvement or a maximum iteration count) applied as configured.

### Method

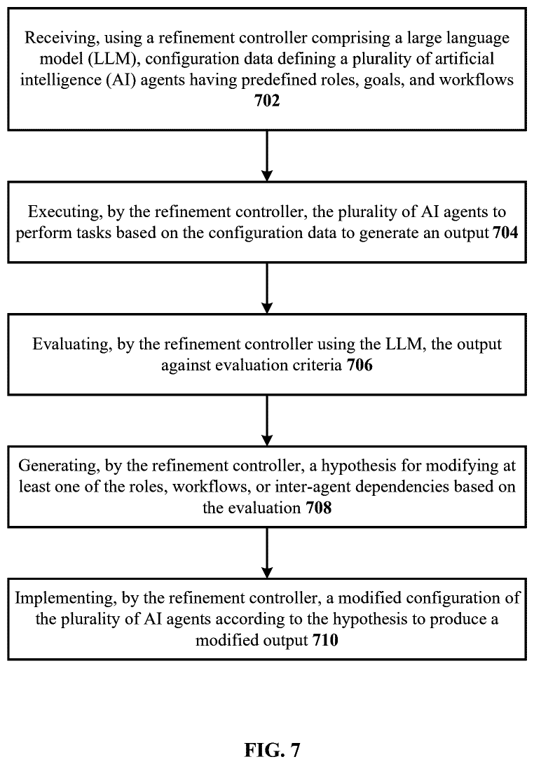

FIG. 7 illustrates an exemplary flow chart depicting initialization and baseline refinement, in accordance with an embodiment of the present disclosure.

At step 702, receiving, using a refinement controller comprising a large language model (LLM), configuration data defining a plurality of artificial intelligence (AI) agents having a plurality of performance attributers including predefined roles, goals, and workflows. The refinement controller ingests role specifications (for example, analyst, retriever, verifier, reporter), goal definitions (for example, required sections, target depth, acceptance thresholds), and workflow artifacts (for example, directed graphs describing sequencing and gating). The refinement controller normalizes formats, validates schema compliance, and assigns a version identifier to the received configuration data so that subsequent executions are traceable to a specific, immutable baseline. Where an idea description is supplied instead of a full configuration, the refinement controller invokes the LLM to infer roles, workflows, and inter-agent dependencies and then registers the inferred configuration as the baseline.

At step 704, executing, by the refinement controller, the plurality of AI agents to perform tasks based on the configuration data to generate an output. Execution instantiates agents according to the workflow graph, routes intermediate artifacts along declared dependency edges, and invokes any bound external tools or data sources referenced in the configuration. Resource and timing controls (for example, per-agent timeouts, concurrency limits, and memory ceilings) are enforced. The execution produces a machine-readable output together with diagnostics (for example, timestamps, tool-call summaries, error traces) that characterize runtime behavior and are preserved for evaluation and debugging.

At step 706, evaluating, by the refinement controller using the LLM, the output against evaluation criteria. The evaluation criteria include qualitative and quantitative matrices such as clarity, relevance, completeness, depth of analysis, actionability, consistency, execution time, and success rate. The LLM produces per-criterion scores and narrative rationales, optionally with suggested remediation points (for example, “insufficient source diversity,” “weak cross-section consistency”). The refinement controller stores the scores, rationales, and the exact evaluation-criteria snapshot used, thereby ensuring that later comparisons reference the same assessment basis.

At step 708, generating, by the refinement controller, a hypothesis for modifying at least one of the roles, workflows, or inter-agent dependencies based on the evaluation. The hypothesis is a concrete, testable change derived from the observed deficiencies or opportunities. Examples include revising a role prompt to increase depth of analysis, inserting a verification step before reporting to improve consistency, re-ordering two workflow stages to strengthen evidence synthesis, or rebinding a tool connector to a different API to reduce execution time. Each hypothesis is recorded with a rationale linked to the evaluation outputs for auditability.

At step 710, implementing, by the refinement controller, a modified configuration of the plurality of AI agents according to the hypothesis to produce a modified output. Implementation applies the selected hypothesis to prompts, code modules, tool bindings, and dependency edges. The modified configuration is validated for executability (for example, acyclicity of the dependency graph, availability of bound tools) and assigned a new version identifier. The refinement controller marks lineage from the baseline version to the modified version so that the resulting modified output can be compared deterministically to prior outputs and reproduced as needed.

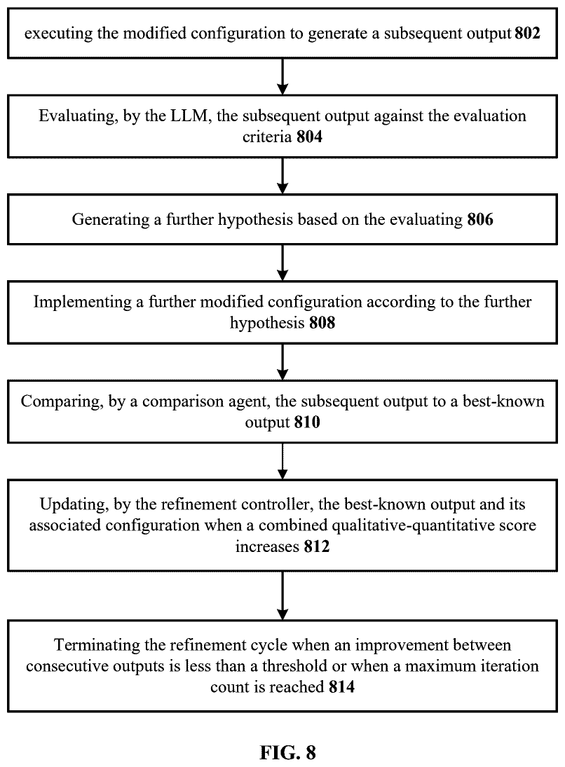

FIG. 8 illustrates an exemplary flow chart depicting an iterative refinement loop with explicit comparison and update actions, in accordance with an embodiment of the present disclosure.

At step 802, executing the modified configuration to generate a subsequent output. The execution follows the declared workflows and inter-agent dependencies, and captures diagnostics, for example, per-agent latency, success/failure counts, tool-call outcomes, needed for quantitative scoring and later fault analysis. The subsequent output is stored with a reference to the exact configuration version that produced it.

At step 804, evaluating, by the LLM, the subsequent output against the evaluation criteria. The LLM applies the current evaluation-criteria snapshot and returns per-criterion scores and rationales. Where the configuration changes targeted specific weaknesses, the evaluation highlights whether the targeted criteria improved, for example, observed increase in actionability with minimal impact on execution time. The refinement controller associates the evaluation record with the configuration and output identifiers.

At step 806, generating a further hypothesis based on the evaluating. The further hypothesis refines prior changes or targets remaining gaps. Examples include tightening a gating dependency when consistency remains low, adding a retrieval pass to increase completeness, or adjusting a summarization strategy to improve clarity. The refinement controller may prioritize multiple candidate hypotheses using historical correlations between change types and observed score improvements.

At step 808, implementing a further modified configuration according to the further hypothesis. The further modified configuration is produced under version control, with explicit edits and lineage recorded from the immediately preceding version. Pre-execution validation ensures the workflow remains executable and the bound services remain reachable, thereby preventing runtime failures unrelated to the intended hypothesis.

At step 810, comparing, by a comparison agent, the subsequent output to a best-known output. The comparison agent performs pairwise or rank-based scoring using the evaluation criteria and emits a comparison result identifying whether the subsequent output exceeds, ties, or underperforms the best-known output. The comparison agent does not mutate any persistent pointer to the best-known artifacts, thereby preserving a strict separation between comparing and updating.

At step 812, updating, by the refinement controller, the best-known output and its associated configuration when a combined qualitative-quantitative score increases. The refinement controller advances persistent references to designate the new best-known output and configuration, while retaining prior best-known references for rollback, audit, and longitudinal analysis. If no improvement is shown, the best-known references remain unchanged and the subsequent output is retained as a non-selected variant.

At step 814, terminating the refinement cycle when an improvement between consecutive outputs is less than a threshold or when a maximum iteration count is reached. Thresholds may include absolute score deltas, moving-average gains, or time-budget limits. If termination criteria are not met, control returns to step 802, thereby continuing the execute-evaluate-hypothesize-modify-compare-update loop under the active evaluation criteria.

### Computer Architecture

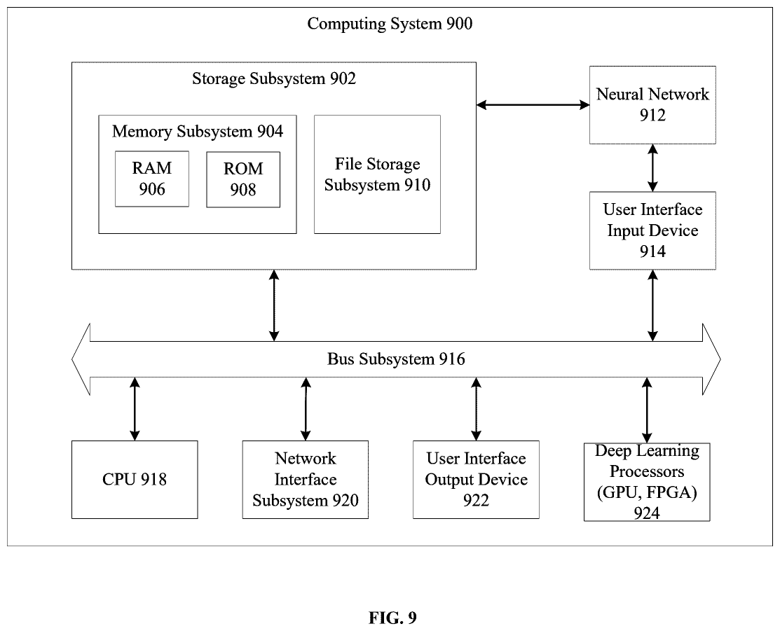

FIG. 9 shows an example computer system 900 that can be used to implement the technology disclosed. The computer system 900 is a representation of the AI agent system 106, as described in FIG. 1A-FIG. 1D, and the refinement controller 204, as described in FIG. 2. The computer system 900 includes at least one central processing unit (CPU) 918 that communicates with a number of peripheral devices via bus subsystem 916. These peripheral devices can include a storage subsystem 902 including, for example, memory devices and a file storage subsystem 910, user interface input devices 914, user interface output devices 922, and a network interface subsystem 920. The input and output devices allow user interaction with computer system 900. Network interface subsystem 920 provides an interface to outside networks, including an interface to corresponding interface devices in other computer systems.

In one implementation, a neural network 912 is communicably linked to the storage subsystem 902 and the user interface input devices 914.

User interface input devices 914 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 900.

User interface output devices 922 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 900 to the user or to another machine or computer system.

Storage subsystem 902 stores programming and data constructs that provide the functionality of some or all of the modules and methods described herein. These software modules are generally executed by deep learning processors 924.

Deep learning processors 924 can be graphics processing units (GPUs), field-programmable gate arrays (FPGAs), application-specific integrated circuits (ASICs), and/or coarse-grained reconfigurable architectures (CGRAs). Processors 924 can be hosted by a deep learning cloud platform such as Google Cloud Platform™, Xilinx™, and Cirrascale™ Examples of processors 924 include Google's Tensor Processing Unit (TPU)™, rackmount solutions like GX4 Rackmount Series™, GX6 Rackmount Series™, NVIDIA DGX-1™ Microsoft's Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™ Fujitsu DPI™, ARM's DynamicIQ™, IBM TrueNorth™, Lambda GPU Server with Testa V100s™, and others.

Memory subsystem 904 used in the storage subsystem 902 can include a number of memories including a main random-access memory (RAM) 906 for storage of instructions and data during program execution and a read only memory (ROM) 908 in which fixed instructions are stored. A file storage subsystem 910 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 910 in the storage subsystem 902, or in other machines accessible by the processor.

Bus subsystem 916 provides a mechanism for letting the various components and subsystems of computer system 900 communicate with each other as intended. Although bus subsystem 916 is shown schematically as a single bus, alternative implementations of the bus subsystem can use multiple buses.

Computer system 900 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 900 depicted in FIG. 9 is intended only as a specific example for the purpose of illustrating the preferred implementations of the present technology disclosed. Many other configurations of computer system 900 are possible having more or fewer components than the computer system depicted in FIG. 9.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 9, computer system/server in computing node 900 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are conFIG.d to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Artificial Intelligence System Implementation

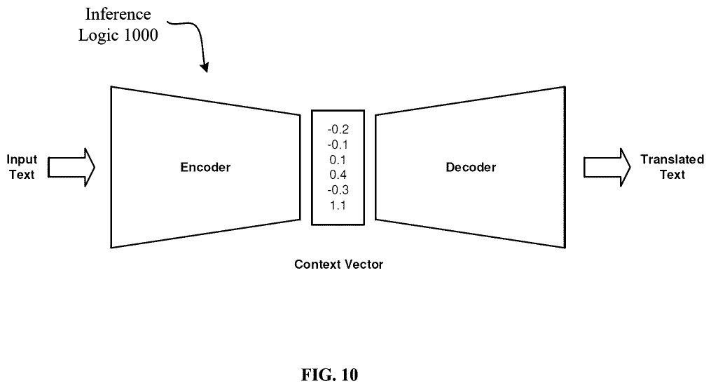

The system described in conjunction with FIG. 2 comprises one or more subsystems based on Artificial Intelligence. Implementation of the subsystems based on the Artificial Subsystems is illustrated by FIGS. 10 to 19.

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, RoBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depth-wise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 10 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

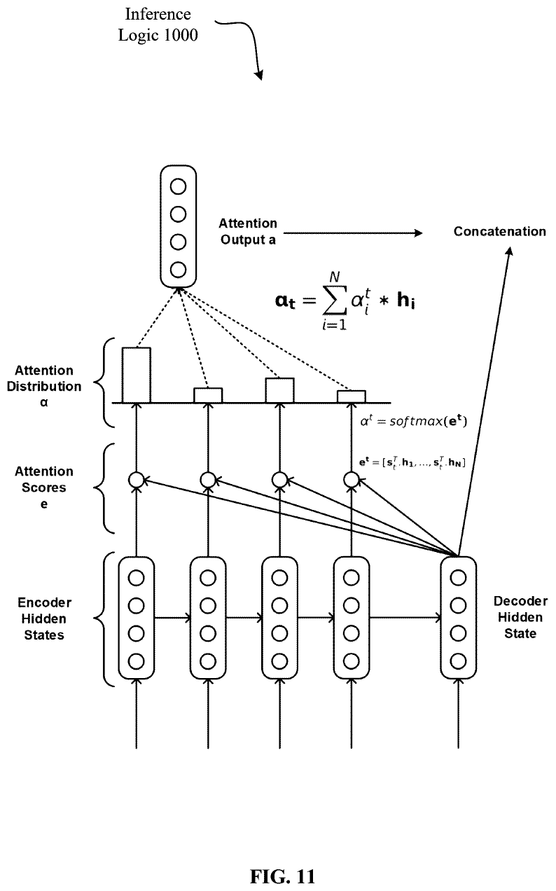

Attention mechanisms distinguish Transformers from other machine learning models. The attention mechanism provides a solution for the vanishing gradient problem. FIG. 11 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

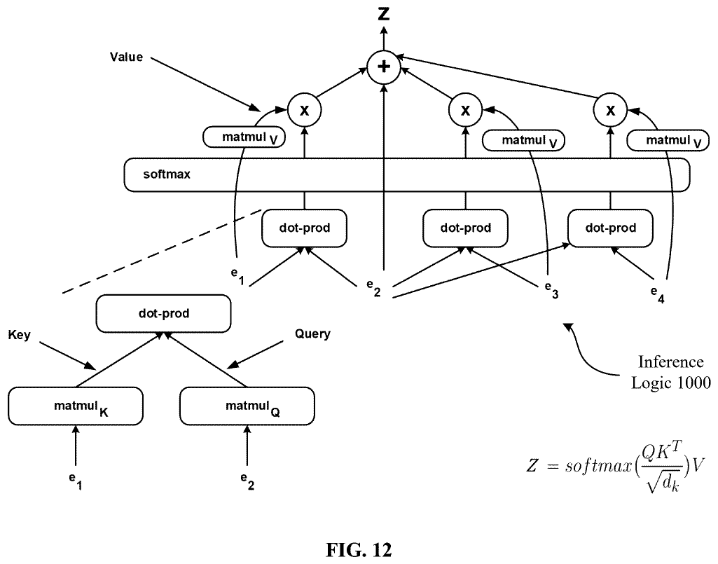

Multi-headed attention is executed in the Transformer. FIG. 12 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

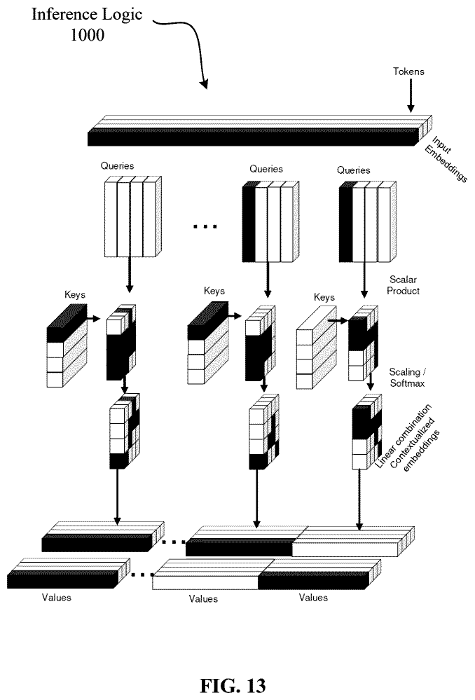

FIG. 13 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{d}k.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{Q {K}^{T}}{\sqrt{d k}} ) V$$

where Q, K, V are computed as:

$$X \cdot {W}_{Q} , X \cdot {W}_{K} , X \cdot {W}_{V}$$

X is the input matrix and WQ, WK, WV are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:
MultiHeadAttention (Q, K, V)=[head1, . . . , headh]W0 where

$$headi = Attention ( {QW}_{i}^{Q} , {KW}_{i}^{K} , {VW}_{i}^{V} )$$

The outputs of all heads are concatenated together and projected again using the learned weights matrix W0 to match the dimensions expected by the next block of heads or the output of the Transformer. Using the multi-head attention instead of the simpler scaled dot-product attention enables Transformers to jointly attend to information from different representation subspaces at different positions.

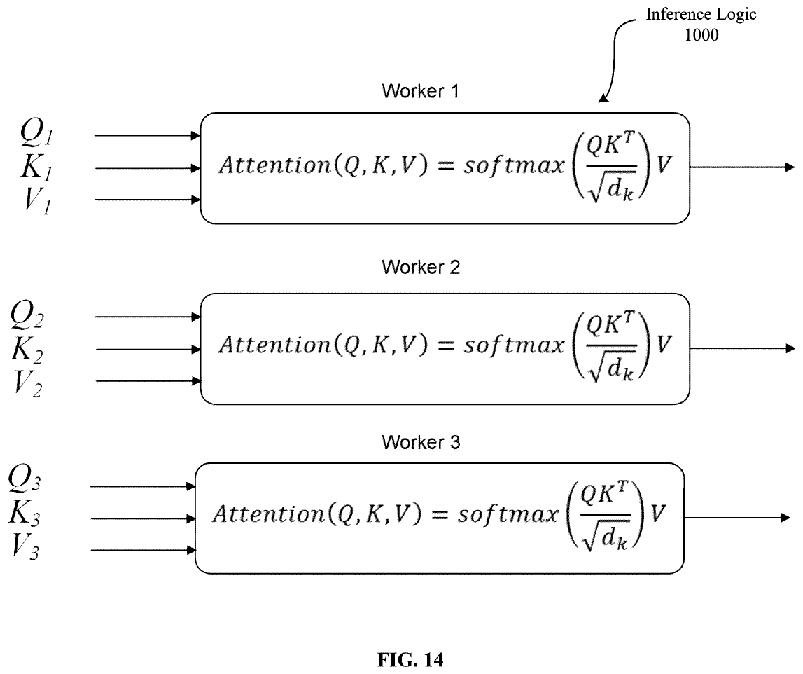

As shown in FIG. 14, one can use multiple workers to compute the multi-head attention in parallel, as the respective heads compute their outputs independently of one another. Parallel processing is one of the advantages of Transformers over RNNs.

As shown in FIG. 14, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

$$a \cdot b \cdot c$$

For matrices of shape (a, b) and (c, d), to obtain values Q, K, V, we need to compute the operations:

$$X \cdot WQ , X \cdot WK , X \cdot WV$$

The matrix X is of shape (n, d) where n is the number of patches and d is the hidden vector dimension. The weights WQ, WK, WV are all of shape (d, d). Omitting the constant factor 3, the resulting complexity is:

$$n \cdot d 2$$

We can proceed to the estimation of the complexity of the attention function itself, i.e., of

$$SoftMax ( \frac{Q {K}^{T}}{\sqrt{d k}} ) V .$$

The matrices Q and K are both of shape (n, d). The transposition operation does not influence the asymptotic complexity of computing the dot product of matrices of shapes (n, d)·(d, n), therefore its complexity is:

$$n 2 \cdot d$$

Scaling by a constant factor of \sqrt{d}k, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{Q {K}^{T}}{\sqrt{d k}} ) \cdot V$$

is between matrices of shapes (n, n) and (n, d) and so its complexity is:

$$n 2 \cdot d$$

The final asymptotic complexity of scaled dot-product attention is obtained by summing the complexities of computing Q, K, V, and of the following attention function:

$$n \cdot d 2 + n 2 \cdot d .$$

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

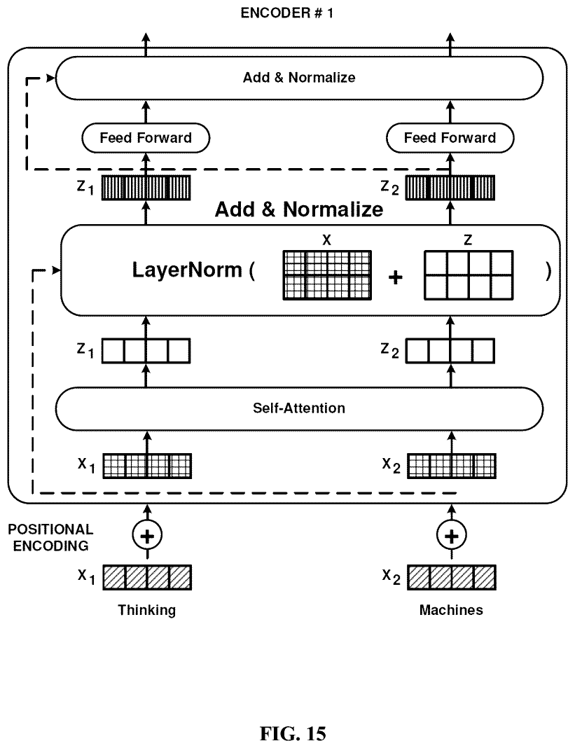

FIG. 15 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

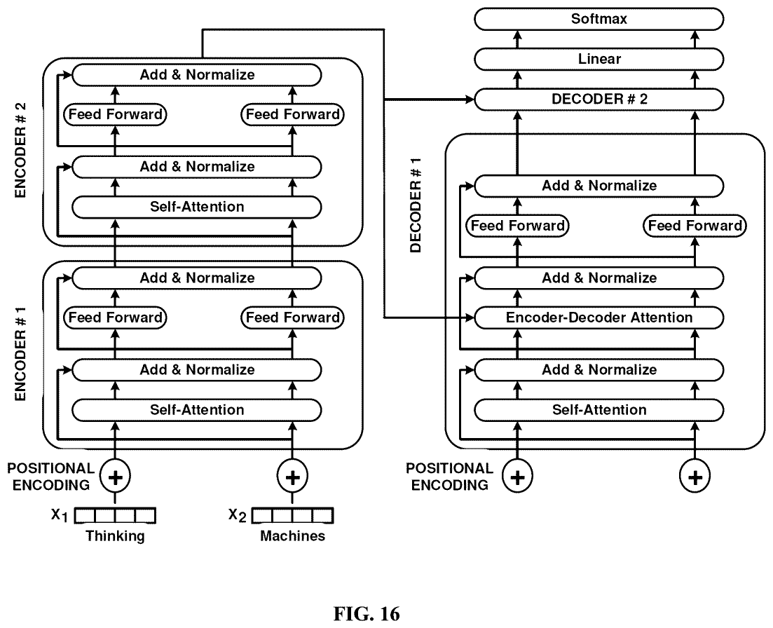

FIG. 16 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

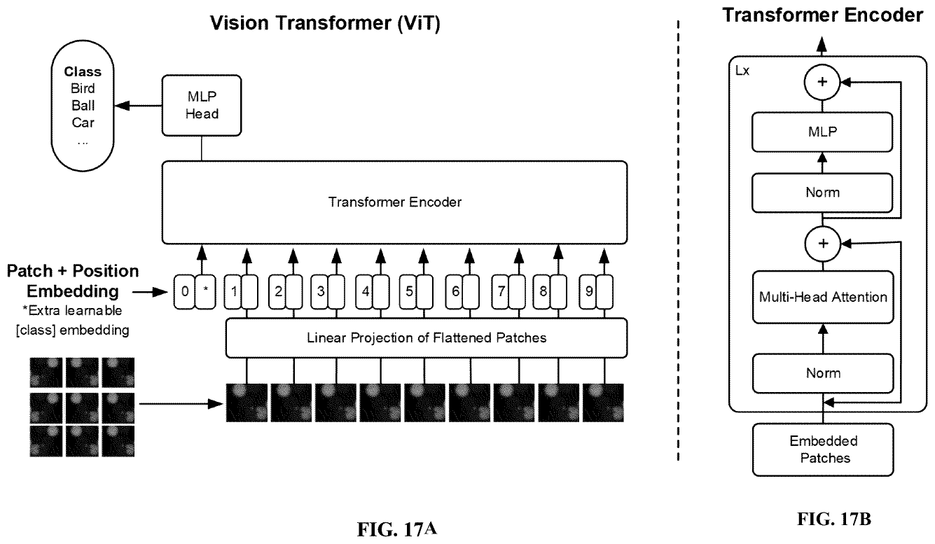

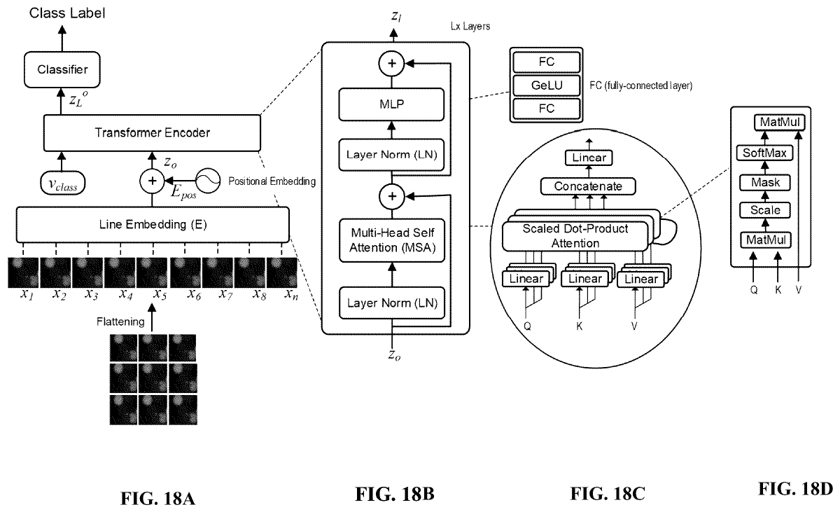

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 17A, 17B, 18A, 18B, 18C, and 18D. Unfortunately, important positional information is lost because image sets are position-invariant. This problem is solved by adding a learned positional encoding into the image patches.

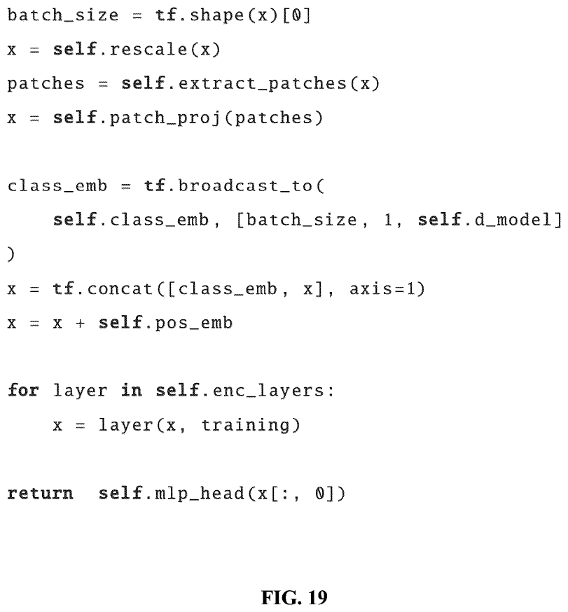

The computations of the ViT architecture can be summarized as follows. The first layer of a ViT extracts a fixed number of patches from an input image (17A). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 19.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block in FIG. 17B, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections, these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method, comprising:
receiving, using a refinement controller comprising a large language model (LLM), configuration data defining a plurality of artificial intelligence (AI) agents having a plurality of performance attributers including predefined roles, objective, workflows;
executing, by the refinement controller, the plurality of AI agents to perform tasks based on the configuration data to generate an output;
evaluating, by the refinement controller using the LLM, the output against evaluation criteria;
generating, by the refinement controller, a hypothesis for modifying at least one of the plurality of performance attributes based on the evaluation; and
implementing, by the refinement controller, a modified configuration of the plurality of AI agents according to the hypothesis to produce a modified output.

2. The method of claim 1, further comprising generating, by the LLM, qualitative and quantitative evaluation criteria including at least clarity, relevance, completeness, depth of analysis, actionability, consistency, execution time, and success rate.

3. The method of claim 1, further comprising initializing, by the refinement controller, the plurality of AI agents from an idea description by analyzing the idea description with the LLM to infer the roles, goals, workflows, and inter-agent dependencies.

4. The method of claim 1, further comprising:
generating, by the refinement controller, a plurality of hypotheses;
implementing, by the refinement controller, a plurality of modified configurations according to respective hypotheses; and
executing the plurality of modified configurations in parallel to obtain corresponding outputs.

5. The method of claim 1, further comprising recording, by a documentation module of the refinement controller, the hypothesis, configuration modifications, evaluation results, ranking decisions, and rationales in a machine-readable log.

6. The method of claim 1, further comprising revising, by the refinement controller, the evaluation criteria across iterations based on observed performance trends.

7. The method of claim 1, further comprising integrating, by the refinement controller, external tools and data sources during execution for information retrieval, report generation, market research, or validation of agent outputs.

8. The method of claim 1, further comprising repeating, by the refinement controller, a refinement cycle that includes:
executing the modified configuration to generate a subsequent output;
evaluating, by the LLM, the subsequent output against the evaluation criteria;
generating a further hypothesis based on the evaluating;
implementing a further modified configuration according to the further hypothesis;
comparing, by a comparison agent, the subsequent output to a best-known output;
updating, by the refinement controller, the best-known output and its associated configuration when a combined qualitative-quantitative score increases; and
terminating the refinement cycle when an improvement between consecutive outputs is less than a threshold or when a maximum iteration count is reached.

9. The method of claim 8, wherein the comparison agent determines a top-performing variant based on pairwise or rank-based scoring relative to the best-known output.

10. The method of claim 1, wherein evaluating the output comprises analyzing, by the LLM, a depth of analysis relative to agent objectives and determining whether the output provides actionable insights aligned with system objectives.

11. The method of claim 1, further comprising:
executing, by an execution agent, the modified configuration;
debugging, by the execution agent, agent interactions; and
gathering outputs for the evaluating.

12. The method of claim 1, further comprising:
storing, by a memory, successful and failed configurations together with associated hypotheses, metrics, and rationales;
retrieving, by the refinement controller, a stored configuration and its output; and
comparing the retrieved output against a newly generated output to support subsequent iterations.

13. The method of claim 1, further comprising prioritizing, by the refinement controller, hypotheses for implementation based on predicted impact derived from historical evaluation data, and generating, by the LLM, a narrative explanation describing rationale, context, and expected improvement for an implemented modification.

14. A system comprising:
at least one processor; and
a memory storing computer-executable instructions that, when executed by the at least one processor, cause the system to:
receive, using a refinement controller comprising a large language model (LLM), configuration data defining a plurality of artificial intelligence (AI) agents having a plurality of performance attributers including predefined roles, goals, and workflows;
execute, by the refinement controller, the plurality of AI agents to perform tasks based on the configuration data to generate an output;
evaluate, by the refinement controller using the LLM, the output against evaluation criteria;
generate, by the refinement controller, a hypothesis for modifying at least one of the plurality of performance attributes based on the evaluation; and
implement, by the refinement controller, a modified configuration of the plurality of AI agents according to the hypothesis to produce a modified output.

15. The system of claim 14, the system is further configured to initialize the plurality of AI agents from an idea description by analyzing the idea description with the LLM to infer the roles, goals, workflows, and inter-agent dependencies.

16. The system of claim 14, the system is further configured to identify areas of improvement by analyzing previous outputs based on LLM-generated qualitative and quantitative criteria and proposes specific hypotheses for optimizing agent roles, workflows, and inter-agent dependencies.

17. The system of claim 14, the system is further configured to:
run and debug multiple configurations;
assess agent outputs using predefined or LLM-generated qualitative metrics and provide feedback;
synthesize new configurations of the multi-agent system by modifying agent logic, roles, tasks, and workflows based on hypotheses; and
compare outputs generated by modified configurations against a best-known output to determine a top-performing variant.

18. The system of claim 14, the system is further configured to include a memory configured for storing and retrieving best-performing agent configurations and their outputs, enabling the refinement controller to reference a stored configuration in a subsequent iteration and compare referenced output against an output produced by a newly generated variant.

19. The system of claim 14, the system is further configured to dynamically create or modify the plurality of AI agents to interact with external tools for gathering information, generating reports, performing market research, or adapting workflows to accommodate changing objectives, data sources, or performance feedback.

20. A non-transitory computer-readable storage medium storing instructions which, when executed by at least one processor, cause the at least one processor to perform operations comprising:
receiving, using a refinement controller comprising a large language model (LLM), configuration data defining a plurality of artificial intelligence (AI) agents having a plurality of performance attributers including predefined roles, objective, workflows;
executing, by the refinement controller, the plurality of AI agents to perform tasks based on the configuration data to generate an output;
evaluating, by the refinement controller using the LLM, the output against evaluation criteria;
generating, by the refinement controller, a hypothesis for modifying at least one of the plurality of performance attributes based on the evaluation; and
implementing, by the refinement controller, a modified configuration of the plurality of AI agents according to the hypothesis to produce a modified output.
